(19) United States
(12) Patent Application Publication
(10) Pub. No.: US 2026/0299994 A1
(43) Pub. Date: Oct. 1, 2026

(54) SYSTEMS AND METHODS FOR INTERRUPT REQUEST PROCESSING

(71) Applicant: Google LLC, Mountain View, CA (US)

(72) Inventors: Ali Taha, San Diego, CA (US); Seyed Hossein Sadat Kooch Mohtasha, San Diego, CA (US); Seyed Hamed Fatemi, San Jose, CA (US); Vinu Vijay Kumar, Belmont, CA (US)

(21) Appl. No.: 19/576,892

(22) Filed: Mar. 24, 2026

Related U.S. Application Data
(60) Provisional application No. 63/779,540, filed on Mar. 28, 2025.

(51) Int. Cl. G06F 9/48

(52) U.S. Cl. CPC G06F 9/4818

(57) ABSTRACT

Methods, systems, and apparatus for reducing power consumption in interrupt request processing. A computing system can include a system-on-chip (SoC), which in turn can include a central processing unit (CPU), an embedded processor, an interrupt handler and at least one hardware accelerator. The interrupt handler can receive interrupt requests from the SoC and route certain types of interrupt requests to the embedded processor for processing, instead of the CPU. This alleviates the need for the CPU to wake up from a lower power state to process particular interrupt requests.

### CROSS REFERENCE TO RELATED APPLICATIONS

This application claims priority to U.S. Provisional Application No. 63/779,540 filed on Mar. 28, 2025. The disclosure of the prior application is considered part of and is incorporated by reference in the disclosure of this application.

### TECHNICAL FIELD

This specification relates to processing of interrupt requests and more particularly to systems and methods for interrupt request processing using an embedded processor implemented on a system-on-chip.

### BACKGROUND

An interrupt request is a signal sent to a system's central processing unit (CPU) by a hardware or software component of the system indicating an event that needs attention from the CPU. For example, an interrupt request can be a keyboard input where the device sends an interrupt request to the processor when a keyboard key is pressed to display the corresponding character on the screen. As another example, an interrupt request can be a timer interrupt, which can be, e.g., a periodic interrupt that occurs at regular intervals to update the system clock or manage background tasks, e.g., memory cleanup.

An interrupt request (IRQ) can cause a CPU (or a core of the CPU) to temporarily halt its processing of current tasks, save its state, and process the received interrupt, either immediately or with some delay. After the CPU (and the underlying operating system) handle/s an interrupt, the CPU can resume processing of previous tasks.

However, not all interrupt requests are critical events and often, more trivial interrupts interrupt CPU processing or require the CPU to wake up from a low power state to process the interrupt request. A critical event, or critical IRQ, can represent interrupts that require immediate attention due to their importance in maintaining system stability and/or to the current processing of the CPU. For example, in a video streaming process, critical interrupts can include network interrupts for when new data packets arrive from the network, buffer management interrupts that manage playout buffer to ensure continuous playback, and display interrupts that manage the rendering of video frames on a device.

On the other hand, a trivial event, or trivial IRQ, can represent interrupts that involve less urgent tasks that do not impact system performance when processed with a delay or do not impact current processes being executed by the CPU. For example, when a CPU is executing a video streaming process, it can receive trivial interrupt request that can include, e.g., timer interrupts that update the system clock, memory cleanup interrupts, or handshaking interrupts that synchronize communication between two system components.

### SUMMARY

This specification describes techniques for reducing power consumption in interrupt request processing. A system-on-chip (“SoC”) can include an embedded processor and an interrupt handler. The SoC can further include a CPU, and at least one hardware accelerator such as an image signal processor (“ISP”), digital signal processor (“DSP”), a graphics processing unit (“GPU”), or a tensor processing unit (“TPU”). During one or more processes being executed by the SoC, the interrupt handler can route the processing of particular interrupt requests to the embedded processor instead of the CPU. In particular, the embedded processor can schedule and process certain interrupt requests, thereby offloading processing of such interrupts from the CPU, which can then focus on other higher priority processing tasks or enter into and/or remain in a lower power state for an interval of time. The embedded processor can be configured such that power consumed in executing interrupt requests in the embedded processor is less than the power consumed in executing the same interrupt request in the CPU.

One general aspect includes a method implemented at a computing device that includes a system-on-chip. The method also includes receiving, from a first process executing on the computing device, a first interrupt request; and determining, by an interrupt handler and based on one or more attributes of the first interrupt request, that processing of the first interrupt request is to be routed to the embedded processor instead of the CPU. The method also includes routing, by the interrupt handler, the first interrupt request to the embedded processor; and receiving, from the embedded processor and by the interrupt handler, confirmation that the first interrupt request has been processed by the embedded processor.

Implementations may include one or more of the following features.

In some implementations, the first interrupt request includes timer interrupts, handshaking interrupts and communication interrupts between one or more IP blocks in the system-on-chip. In some implementations, the attributes of the first interrupt request includes whether the first interrupt request is host agnostic or not.

In some implementations, the attributes of the first interrupt request include the frequency of the first interrupt request.

In some implementations, the first interrupt request can be dynamically assigned or assigned to the embedded processor based on preconfiguration that identifies the first interrupt request and routes it to the embedded processor.

In some implementations, assigning based on preconfiguration during preconfiguration can include analyzing a set of interrupt requests and for each interrupt request, determining an assigned processor; and preconfiguring the interrupt handler to route each of the interrupt requests to the assigned processor.

In some implementations, dynamically assigning the first interrupt request can include: identifying and matching one or more attributes of the first interrupt request to the embedded processor.

In some implementations, dynamically assigning the first interrupt request can further include: comparing attributes of the first interrupt request with predetermined attributes that are aligned with processing of interrupts by the embedded processor.

In some implementations, the embedded processor has lower power consumption than the CPU.

In some implementations, the CPU enters into or remains in a particular low power state when the first interrupt request is routed to the embedded processor.

In some implementations, the method may further include: receiving, from a second process executing on the computing device, a second interrupt request, determining, by the interrupt handler and based on one or more attributes of the second interrupt request, that processing of the second interrupt request is to be routed to the CPU, routing, by the interrupt handler, the second interrupt request to the CPU, and receiving, from the CPU and by the interrupt handler, confirmation that the second interrupt request has been processed by the CPU.

In some implementations, the computing device is a mobile device.

In some implementations, the first process executed on the mobile device is a video streaming process.

In some implementations, the first interrupt request is a timer interrupt that is configured to repeatedly trigger after a short time interval to check for new messages or perform background updates on the mobile device.

In some implementations, the embedded processor is a synchronization and scheduling unit (SSU).

Particular examples of the subject matter described in this specification can be implemented so as to realize one or more of the following advantages.

For example, in environments where a SoC includes a CPU and an embedded processor, the techniques described herein can enable processing of interrupt requests to be performed on the embedded processor instead of on the CPU. As the power consumed in handling of the interrupt requests on the embedded processor can be less than the power consumed in handling of the same interrupt request on the CPU, performing interrupt request operations on the embedded processor can reduce power consumption. While in some examples, one or more operations in the CPU can be disabled, the complexity of the CPU itself contributes to the high power consumption. The CPU may include multiple CPU cores intended to perform general application processing and can have a complex instruction set architecture, processing pipelines, and memory architecture, all of which result in high power consumption for processing of even the simplest processes or interrupts. For example, the complex architecture of a multi-core CPU generally includes more transistors, additional circuitry, more power to decode and execute instructions, increasing overall power consumption. Embedded processors, on the other hand, can be relatively simpler, have a smaller instruction set architecture, processing pipelines and memory architecture, resulting in lower power consumption than the CPU.

The details of one or more embodiments of the subject matter of this specification are set forth in the accompanying drawings and the description below. Other features, aspects and advantages of the subject matter will become apparent from the description, the drawings, and the claims.

### BRIEF DESCRIPTION OF THE DRAWINGS

FIG. 1 is a block diagram of an example computing system.

FIG. 2 is a diagram of an example flow of receiving and routing one or more interrupt requests from the interrupt handler during execution of one or more processes in an SoC.

FIGS. 3A, 3B and 3C demonstrate the disruption of low power state time intervals by interrupt requests when processed by the CPU.

FIG. 4 shows a graph of the CPU power states.

FIG. 5 shows multiple graphs that illustrate the power levels for the CPU power states, including entrance and exit power requirements.

FIG. 6 shows a flow diagram of an example process of routing an interrupt request to the embedded processor.

FIG. 7 shows a flow diagram of an example process of routing an interrupt request to the CPU.

Like reference numbers and designations in the various drawings indicate like elements.

### DETAILED DESCRIPTION

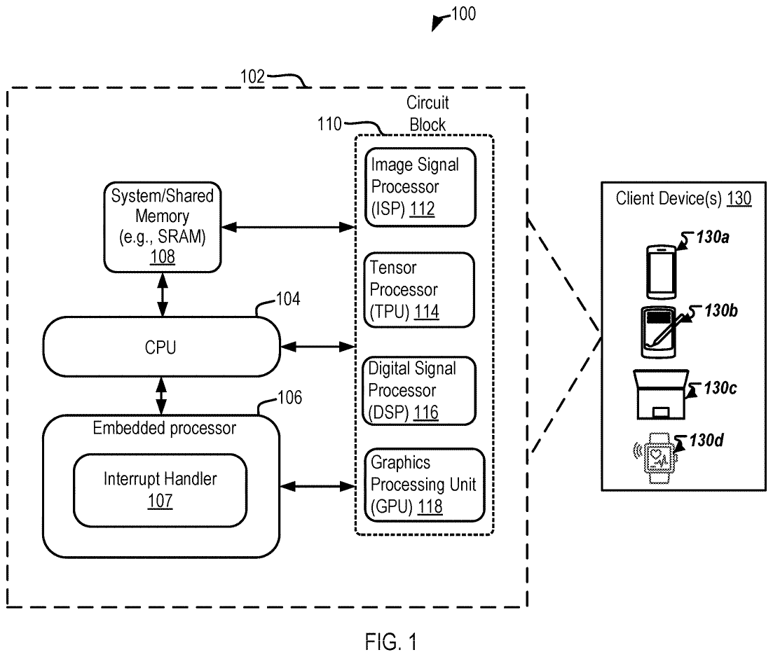

FIG. 1 is a block diagram of an example computing system 100. The example computing system 100 can include a system-on-chip 102 (“SoC 102”), which, in turn, can include a central processing unit (CPU) 104, an embedded processor 106, a shared memory 108, and an IP/circuit block 110. The SoC 102 can be implemented in an integrated circuit of an example user/client device 130, consumer device, or mobile device, where each of these devices can include items such as a smartphone 130a, a tablet 130b, a laptop 130c, and a smartwatch or wearable device 130d. The client device 130 may also include other items such as an eNotebook, Netbook, smart speaker, or mobile computer. In some examples, the system 100 and the SoC 102 is an integrated circuit of a desktop computer, network server, or related cloud-based asset. The SoC 102 can also include an interrupt handler 107.

While FIG. 1 shows the interrupt handler 107 as a part of the embedded processor 106, in some implementations, the interrupt handler 107 can be separate from the embedded processor 106. For example, the interrupt handler 107 can be implemented as part of the CPU. As another example, the interrupt handler 107 can be implemented as logic implemented by another processing unit of the SoC.

The CPU 104 can be a general-purpose CPU (e.g., a single or multi-core CPU). In some implementations, the CPU 104 can be an eight core processor where one or more cores of the CPU can be in low power state while one or more other CPU cores is/are processing events of the one or more current processes. An operating system can run on the CPU 140. Examples of operating systems can include the Android operating system, the iOS operating system, the Windows operating system, etc. The operating system can run one or more processing applications for the one or more current processes. For example, the operating system 142 can run one or more processing applications for a video streaming process. As another example, the operating system can run one or more image processing applications, including photography applications, video call applications, authentication applications, face recognition applications, etc. The operating system 142 can include one or more hardware drivers that allow applications running on the operating system 142 to control hardware.

The SoC 102 also can include the embedded processor 106, which can carry out specific functions related to interrupt requests. In particular, the embedded processor 106 can process at least some interrupt requests and can include a synchronization unit.

The synchronization unit can synchronize communications between various elements of the SoC 102. For example, the synchronization unit can synchronize communications between the embedded processor and processing units in the circuit block 110 some of which could include hardware accelerators. The synchronization unit can dynamically control and manage one or more synchronization events that are executed on the SoC 102 in support of processing operations. Specifically, the synchronization unit can generate control signaling and use one or more discrete signal values of the control signaling to arrange and synchronize operations between two or more processing units that are included in the circuit block 110, the CPU 104, and the embedded processor 106. An example embedded processor and its associated circuitry and operations is described with reference to App. No. PCT/US2511841, which is incorporated by reference in its entirety here.

The interrupt handler 107 can include programming instructions that are executed by the CPU and can perform its operations upon instruction execution. The interrupt handler 107 can receive and route interrupt requests to the embedded processor 106 or the CPU 104. The interrupt handler 107 can determine whether processing of the received interrupt request should be routed to the embedded processor 106 or the CPU 104 depending on the interrupt request. Determining whether to route to the embedded processor 106 or the CPU 104 can be done dynamically, or based on a predetermined configuration, e.g., identifying the type of interrupt request and then routing to the processor assigned to that type of interrupt request.

The memory 108 is a system memory, shared memory, or both. In the example of FIG. 1, memory 108 is depicted external to circuit block 110. However, memory 108 can include portions of memory that are: i) specific to and internal to circuit block 110, ii) external to circuit block 110, or iii) both. The memory 108 can be random access memory of the SoC 102, such as static random-access memory (SRAM), dynamic random access memory (DRAM), a synchronous DRAM (SDRAM), or double data rate (DDR) SDRAM. In some implementations, aspects of memory 108 are configured as a shared scratchpad memory that supports parallel access of its memory resources by two or more processors of the circuit block 110. The memory 108 can also include various other types of memory, such as high bandwidth memory (HBM), narrow memory (e.g., for storing 8-bit values), wide memory (e.g., for storing 16-bit or 32-bit values), etc.

The circuit block 110 can include processing units, such as an image signal processor (ISP) 112, a tensor processing unit (TPU) 114, a digital signal processor (DSP) 116, and a graphics processing unit (GPU) 118. The circuit block 110 can also be referred to as an IP block 110, where the IP block can include one or more dedicated or proprietary hardware elements. For example, each of the ISP 112, TPU 114, DSP 116, and GPU 118 can be a respective proprietary IP block (or IP device) of a particular entity or device manufacturer.

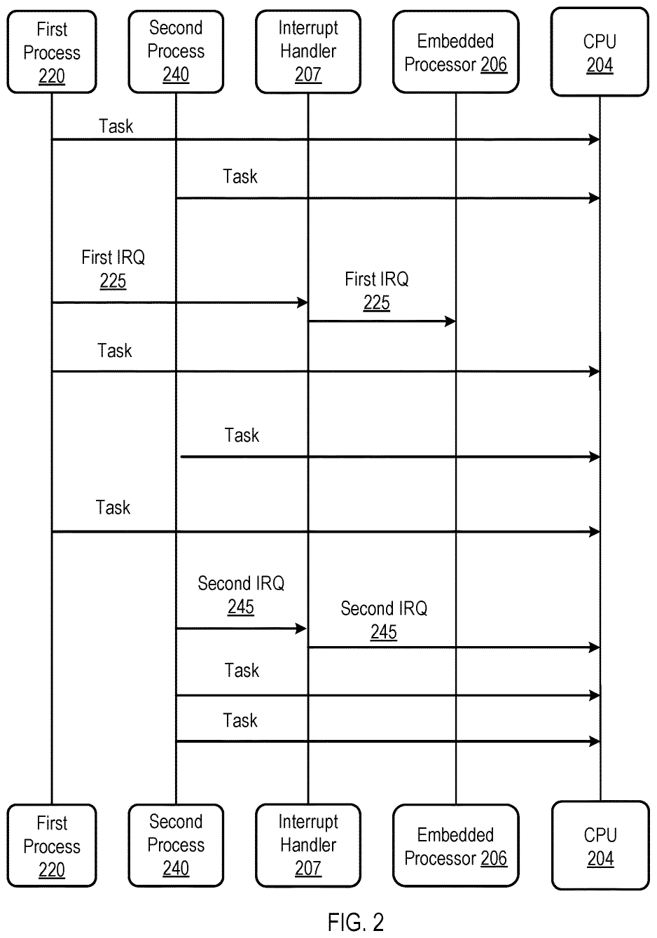

FIG. 2 is a diagram of an example flow of receiving and routing one or more interrupt requests from the interrupt handler during execution of one or more processes in an SoC.

The SoC can execute one or more processes that include one or more processing tasks. For example, the one or more processes can include a video streaming process that includes one or more tasks, such as loading video data, decoding the video data, frame rendering, and any other appropriate tasks. As a specific example for FIG. 2, the SoC can execute a first process 220 and a second process 240 with one or more respective processing tasks.

As demonstrated in FIG. 2, the SoC can receive one or more interrupt requests (IRQ) during execution of the one or more processes. For example, the SoC can receive first IRQ 225 from the first process 220 and second IRQ 245 from the second process 240.

The SoC can receive the one or more interrupt requests at any time during execution of the one or more processes. As seen in FIG. 2, the SoC can receive the one or more interrupt requests before or after, or in some implementations during, the execution of any one or more processing tasks of the CPU 204.

The types of IRQs that can be offloaded to the embedded processor, e.g., first IRQ 225, can include trivial requests of the SoC, e.g., interrupt requests that are not directly related to the current process being executed or essential to the current process's execution. Examples of such interrupt requests include, among others, timer interrupts, handshaking interrupts, and communication interrupts between one or more IP blocks in the SoC that do not directly influence the processing of the system, e.g., does not impact system performance when processed with a delay or does not relate to the current processing of the CPU. As a particular example, in a video streaming process, an interrupt request can be a timer interrupt that is configured to repeatedly trigger after a short time interval to check for new messages or perform background updates on the computing device. In this particular example, the timer interrupt is not a critical event and will not impact the performance of the SoC or its ability to process tasks of the video streaming process if processed with a delay. Nor does the timer interrupt relate to video streaming processing and is an interrupt to manage background tasks on the computing device. That is, the timer interrupt can include tasks that need to be processed/handled by the system, but tasks that are not time or process critical, e.g., the system can maintain its performance while delaying processing of the timer interrupt.

The interrupt requests that are directly related, and/or essential, to the process(es) being executed, e.g., second IRQ 245, are routed to the CPU and not offloaded to the SSU. Examples of such interrupt requests include, among others, network interrupts, exception handling, system calls to execute an operation, and input/output interrupts.

As described above, the SoC can include an interrupt handler 207 that can receive one or more interrupt requests from the one or more processes, e.g., a video streaming process, that is being executed on a computing device (that include the SoC with a CPU and an embedded processor). In some implementations, the interrupt handler 207 can handle multiple interrupts in parallel. That is, the interrupt handler 207 can handle one or more additional interrupts while processing of a first interrupt is ongoing.

The interrupt handler 207 can receive the interrupt request and route the interrupt request to the embedded processor 206 or the CPU 204. The interrupt handler 207 can determine the routing of the interrupt request dynamically or based on a preconfiguration. For example, the interrupt handler 207 can include or have access to a mapping between particular interrupt requests and the processor to which such requests should be routed and based on that mapping can assign the first interrupt request to a particular processor, e.g., the CPU 204 or the embedded processor 206.

In the predetermined configuration-based assignment, the interrupt handler 207 can identify the interrupt request (e.g., by parsing the request to access the identifier of the interrupt request) upon receipt and route it to the preconfigured processor based on a mapping (as may be stored in a table in memory) between interrupt requests and the processor to which such requests are to be routed (e.g., mapping between identifiers of interrupt requests and the respective processor to which it should be assigned). For example, if first IRQ 225 is a timer interrupt that is preconfigured to be routed to the embedded processor 206, when the interrupt handler 207 receives first IRQ 225, it will route it to the embedded processor 206. As another example, if second IRQ 245 is an exception handling interrupt that is preconfigured to be routed to the CPU 204, when the interrupt handler 207 receives second IRQ 245, it will route it to the CPU 204.

In some implementations, for dynamic interrupt request routing, the interrupt handler 207 can include one or more lookup tables (or another data structure) that includes types of interrupts and their attributes that are to be routed to the embedded processor 206 and types of interrupts and their attributes that are to be routed to the CPU 204. In some implementations, one lookup table can be used for types of interrupts and their associated attributes for both of the processors. In some implementations, types of interrupts and their associated attributes for the embedded processor 206 and the CPU 204 are stored in respective lookup tables.

In some implementations of dynamic interrupt request routing, the interrupt handler 207 can compare the attributes of a received interrupt request (e.g., as parsed from metadata included with the interrupt request), e.g., first IRQ 225, with attributes stored in the lookup table for the embedded processor 206 and score the interrupt request based on a correspondence between attributes of the received interrupt request and the attributes in the table to determine if the interrupt request can be offloaded to the embedded processor 206 or not.

In some implementations, the interrupt request can be scored by comparing and determining a match between attributes of the interrupt request and attributes of the embedded processor 206. For example, a match between attributes can be denoted with a score of 1, while no match can be denoted with a score of 0. After each of the attributes of the interrupt request is analyzed, the scores can be summed and compared to a threshold value to determine if the interrupt request can be offloaded to the embedded processor. For example, if attribute X and Y of the received interrupt request match the attributes stored in the lookup table for the types of requests that can be routed to the embedded processor 206, but attribute Z does not, the interrupt handler can still route the interrupt request to the embedded processor 206 if the combined score from such matching satisfies (e.g., meets or exceeds) a threshold value. More specifically, the received interrupt request can have an overall score of 2, e.g., 1 from the match of attribute X, 1 from the match of attribute Y, and 0 from attribute Z, and can still be routed to the embedded processor 206 with a threshold value of 2 or lower.

If none of the attributes of the received interrupt request match the attributes stored in the lookup table for the embedded processor 206 or the score does not satisfy the threshold, the interrupt handler 207 can route the interrupt request to the CPU. For example, in the above example, if the threshold value is 3 or higher, then the received interrupt request is routed to the CPU. As another example, if the overall score of the received interrupt request is 0, e.g., no matches occur, then the received interrupt request is routed to the CPU.

The above process can also be applied to the CPU, e.g., compare the attributes of a received interrupt request with attributes stored in the lookup table for the CPU 204 and score the interrupt request.

In some implementations of dynamic interrupt request routing, a machine learning model can be trained on various interrupt requests, their attributes, and the processor to which they are routed. The machine learning model, so trained, can be used to predict the processor to which an interrupt request should be routed after receiving an interrupt request and its attributes as input.

Based on the above-described determination, the interrupt handler 207 can route the interrupt request to the assigned processor, e.g., either the embedded processor 206 or the CPU 204. By routing an interrupt request to the embedded processor 206, one or more cores of the CPU can enter into or remain in a low power state, lowering power consumption overall while still maintaining processing performance. Moreover, since the embedded processor 206 generally consumes less power than the CPU 204, processing of certain interrupt requests by the embedded processor 206 also achieves more power efficiencies compared with the CPU 204 processing such requests.

However, as demonstrated in FIG. 2, particular interrupt requests, e.g., second IRQ 245, can still be processed by the CPU 204 as it may be essential or relevant to the one or more processes currently executed by the CPU 204.

The assigned processor, either the embedded processor 206 or the CPU 204, can process the interrupt request and send a confirmation to the interrupt handler that the interrupt has been processed. The interrupt handler can continue to listen for other interrupt requests and repeat the above process upon receipt of another interrupt request, while the SoC can continue to execute tasks in the CPU 204 from the one or more processes, e.g., first process 220 and second process 240.

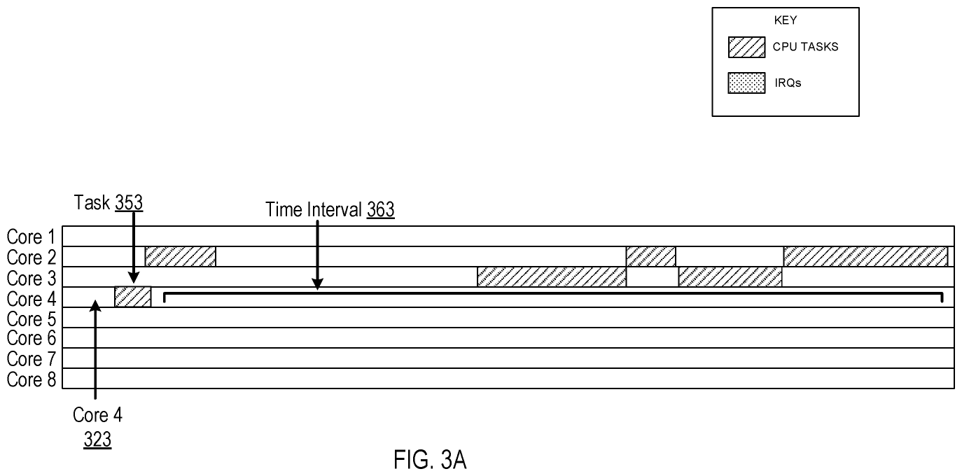

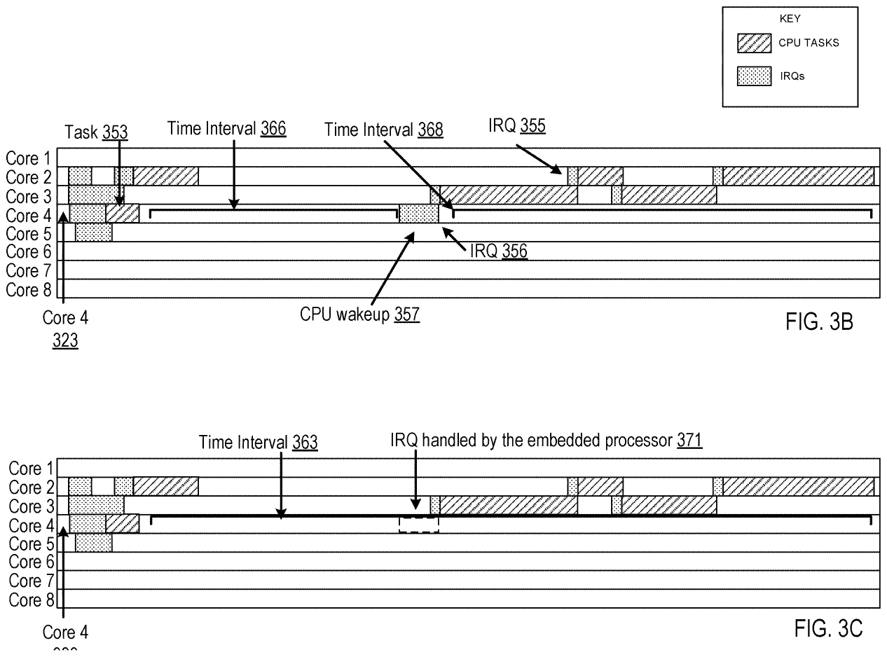

FIGS. 3A, 3B and 3C demonstrate the disruption of low power state time intervals by interrupt requests when processed by the CPU. When interrupt requests are processed by the CPU, the interrupt request can disrupt periods of time in which the CPU can enter a low power state, hindering power saving capabilities. By routing particular interrupt requests to the embedded processor, the CPU can enter into or remain in low power, reducing overall power consumption.

FIGS. 3A, 3B, and 3C show a timing diagram illustrating processing activity for each of the cores of a CPU over time. Each row of these diagrams corresponds to a particular core of the CPU and represents the processing activity over time of that CPU core. For this illustration, it is assumed that the CPU has eight cores, with one or more processing tasks scheduled on/performed by one or more cores. As mentioned above, in a multi-core CPU, one or more cores of the CPU can process the tasks of a current process, e.g., a video streaming process, while one or more other cores of the CPU can be idle, e.g., not processing any tasks. When a CPU core is idle, it can enter and remain in low power state until the core has another task scheduled to process.

For example, as seen in FIG. 3A, CPU core 323 has a task 353 scheduled and then has an extended idle time interval 363 in which it can enter into a low power state and reduce power consumption of that core (and in turn, of the CPU as a whole). As one skilled in the art will appreciate, a CPU core can be pulled into a low power state after it has been idle for a threshold amount of time.

When an interrupt request is received by the SoC, it can be routed for processing by a particular core of the CPU, which can result in that core being woken up from its low power state or prevent it from entering into a low power state in order to process the interrupt request.

FIG. 3B illustrates another timing diagram for the same eight-core CPU as discussed with reference to FIG. 3A, with one or more interrupt requests routed, e.g., routed by an interrupt handler, to be processed by the CPU. As described above, the one or more interrupt requests can be related to the processing tasks of the current process, e.g., interrupt request (IRQ) 355, or not directly related to the current process being executed, e.g., interrupt request (IRQ) 356.

As seen in FIG. 3B, for CPU core 323, an interrupt request (IRQ) 356 can wake up 357 the CPU core 323 and thereby interrupt the extended idle time interval 363 from FIG. 3A to create two separate time intervals: time interval 366 and time interval 368. By splitting the extended idle time interval 363 of FIG. 3A into two separate time intervals, e.g., time interval 366 and time interval 368, the interrupt request 356 disrupts the CPU core 323 in one or more ways.

For example, in some implementations, the CPU core 323 can be woken up 357 from a low power state to process the interrupt request 356, which requires power to transition from the low power state to an active processing state, to process the interrupt request 356, and to subsequently re-enter into a lower power state after processing of the interrupt request is completed.

In some implementations, the CPU core 323 can no longer enter into low power state in one or either of the two time intervals, e.g., time interval 366 and time interval 368, as there may not be enough time to enter and exit low power state before or after processing the interrupt request 356. In this example, the interrupt request can be processed by the higher power CPU core 323 and can remain in the higher power active processing power state in one or either of the time intervals 366, instead of entering into or remaining in a low power state for the entire extended idle time interval 363 of FIG. 3A. That is, processing of an interrupt request 356 by the CPU can maintain or even increase power consumption by the CPU compared to routing the interrupt request to an alternative processor for processing, e.g., the embedded processor 206 of FIG. 2 (as further described below with reference to FIG. 3C).

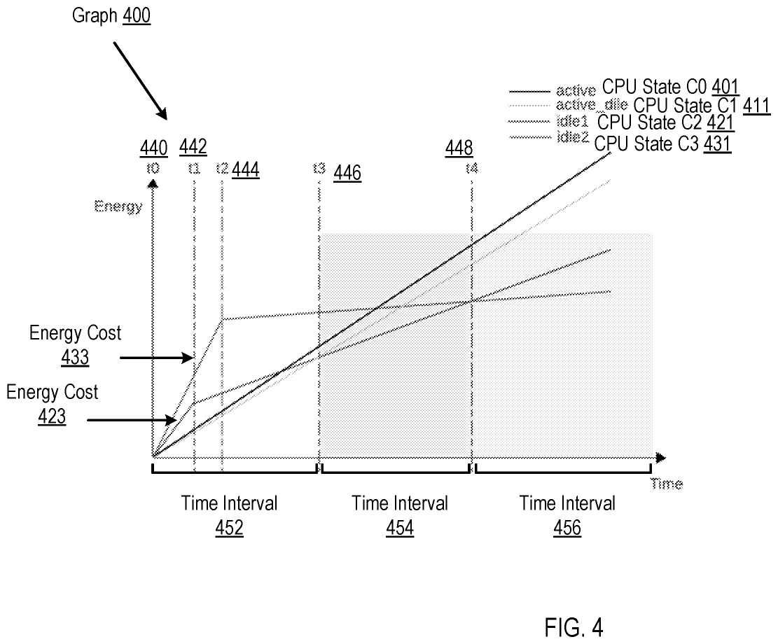

The time and energy consumed by the CPU to transition between power states is described in further detail with reference to FIG. 4.

FIG. 3C illustrates another timing diagram for the same eight-core CPU (as described with reference to FIG. 3A), with the interrupt request (IRQ) 356 handled 371 by the embedded processor, e.g., the embedded processor 206 of FIG. 2, instead of the CPU. This allows the CPU core 323 to remain idle for the extended idle time interval 363, allowing that core to enter into and remain in a low power state. In this example, the IRQ 356 can be processed by a lower power processor and the CPU core 323 can remain in a low power state for an extended period of time, thereby saving power. FIG. 4 shows a graph of the CPU power states. A CPU, e.g., the CPU 104 as described with reference to FIG. 1, can have one or more power states. The one or more power states can range from active processing to shut off. In some implementations, the one or more power states can include and be referred to as power state C0 401, power state C1 411, power state C2 421 and power state C3 431. Although four power states are referenced here, one skilled in the art will appreciate that a system according to the techniques described here can include fewer or additional power states than the four recited earlier. For brevity and ease of description, the following description is provided with reference to these four power states.

While the system can save power by processing an interrupt request in the embedded processor instead of the CPU (as described with reference to FIG. 2), the routing of the interrupt request to the embedded processor can open up an extended time window for the CPU to enter into and remain in a lower power state (as described with reference to FIG. 3). This extended time window can, in some implementations, enable the CPU to save even more power, which will be described in further detail below.

The active states, e.g., power state C0 401 and power state C1 411, represent the higher power states of the CPU, relative to other power states of the CPU. That is, the active states can refer to when the CPU is executing a processing task, or awake and waiting for the next task to perform. The C0 401 power state, also referred to as the active power state, can refer to a power state when the CPU is actively running, e.g., performing tasks or processes. The C1 411 power state, also referred to as the active idle state, can refer to a power state where the CPU is idle and automatic clock gating (ACG) can be used to save power, e.g., the clock signal to particular components of the CPU is automatically turned off when those components are not in use. For example, the clock signal can be turned off to execution units that perform arithmetic and logic operations. As another example, the clock signal to the register files can be turned off as they are not being read from or written to. While in the C1 411 power state, the CPU can save power while maintaining a low latency response time to resume processing execution.

The idle states, e.g., power state C2 421 and power states C3 431, can describe the lower, or deeper, power states of the CPU relative to the earlier active states, e.g., when the CPU is “asleep”. The C2 421 power state, also referred to as the idle 1 power state, can refer to a power state where the CPU reduces power consumption for particular components but utilizes memory retention to retain the contents of memory elements. That is, the CPU can maintain the state of the system without needing to reload data when resuming execution.

The C3 431 power state, also referred to as idle 2 state, can refer to a power state where power gating is used to reduce power by completely shutting off power to particular components of the CPU when they are not in use. For example, one or more of the one or more cores can be powered down when not in use. As another example, execution units and cache memory can also be turned off when the CPU is idle. That is, the CPU can reduce power consumption to zero for certain components by completely shutting off those components. However, entering into and exiting out of C3 431 can require more time and power to restore the CPU to an active state when resuming execution than any of the above mentioned power states.

The one or more cores of the CPU, e.g., the eight-core CPU, can be in any one of the power states. For example, in an eight core CPU, one or more of the cores may be in the C3 341 power state when not in use for the current processing. More specifically, one or more of the cores can be in the C3 431 power state while one or more other CPU cores can be in any one of the other power states. For example, a first CPU core can be in the C0 401, or active state while a second CPU core is in the C2 421 state, a third CPU core is in C1 411 state, and so on.

Graph 400 can illustrate the energy cost for each of the aforementioned power states, e.g., state C0 401, state C1 411, state C2 421, and state C3 431, over a given time interval, e.g., time interval 452, time interval 454 or time interval 456.

In order to enter into or exit out of a particular power state, the CPU has to use a certain amount of energy. For example, power state transitions from a higher power state to a lower power state can include energy-costing operations such as saving the current state of the CPU, e.g., register contents and cache data, reducing the CPU's voltage and frequency, writing data to memory, and any other appropriate operations. As another example, power state transitions between a lower power state to a higher power state can include energy-costing operations such as restoring the previously stored state, e.g., register contents and cache data, reload caches and reinitialize any appropriate components as well as any other appropriate operations. That is, the CPU has to spend energy, and time, transitioning between a high power state and a low power state.

The more the CPU has to save or restore when transitioning, the more energy, and time, the transition takes. For example, the transition between C0 401 and C2 421 can take less time and energy than a transition between C0 401 and C3 431 as the CPU is completely shutting off power of certain parts to save power in power state C3 431 and manages the power supply by turning on and off power switches and saving the current state of the CPU for restoration when it wakes back up. This requires more energy than waking up from power state C2 421, which reduces power consumption in the CPU but retains the contents of cache memory to maintain the state of the system. That is, when transitioning between C0 401 and C3 431, the CPU has to write the data in its caches to main memory to save it while it powers down the caches and other components, while when transitioning between C0 401 and C2 421, the CPU can keep its cache memory and does not have to write any data to memory, requiring less energy. As demonstrated in graph 400, the energy cost 433, which illustrates the energy cost to enter into the C3 431 power state, is steeper, or higher, than the energy cost 423 to enter into the C2 421 power state, from the C0 401 power state. The transition also takes more time, e.g., the time to transition (t2) from C0 401 to C3 431 is longer than the time transition (t1) from C0401 to C2 421.

The energy cost 413 to enter into the C1 411 power state from the C0 401 power state is small, but still shown in graph 400.

To summarize, to enter into the C3 431 power state, the CPU can exert the most energy, followed by the C2 421 power state and then the C1 411 power state. The entrance latencies, e.g., the time it takes to enter into the power states, can be similarly ranked: the C3 431 power state has the highest entry latency, e.g., takes the most time, followed by the C2 421 power state and then the C1 411 power state. That is, power states that take more energy to enter also take more time to enter.

While not shown in graph 400, the same principle is true for exiting the power states as well. To exit the C3 431 power state and return to the active C0 401 state, the CPU can exert the most energy, followed by the C2 421 power state and then the C1 411 power state. The exit latencies, e.g., the time it takes to exit the power states and return to the active C0 401 state, can be similarly ranked: the C3 431 power state has the highest exit latency, e.g., takes the most time, followed by the C2 421 power state and then the C1 411 power state. That is, power states that take more energy to exit also take more time to exit.

As the CPU has to exert time and energy to enter into a low power state, it is not always efficient to transition between power states, or even transition to the lowest power state. For example, if the CPU, currently in power state C0 401, exerts a lot of time and energy to enter into C3 431—more so than entering into states C1 411 and C2 421—but only remains in the power state for a short amount of time, it may not have been in state C3 431 long enough to result in net positive power savings (i.e., when considering power cost to enter state C3 and power savings of this lower power state). That is, depending on the time spent in a lower power state, it may cost more energy to transition back and forth between power states than to just stay within the same power state, or move to a different low power state. In some cases, the CPU does not have enough time to enter into and out of deeper power states, e.g., power state C3 431, before the CPU has another task scheduled to perform.

Based on the above, depending on the time window, e.g., a window of inactivity where a CPU core does not have any tasks, one of the power states can be more efficient to enter into for the CPU than the other power states.

For example, during time interval 452, i.e., between t0 440 and t3 446, the overall energy cost for the CPU is lowest in the C1 411 power state, as demonstrated by the graph. The CPU can only remain in the power state for a short amount of time, and there is not enough time within the time interval to result in net positive power savings (i.e., when considering power cost to enter into state C2 421 or state C3 431 and the power savings of these two power states). Since the energy cost and entry latency is small for entering C1 411, there is no reason to stay in C0 401, or the active state, when the CPU is not doing any processing. Therefore, the C1 411 power state is the most efficient power state to reside in from t0 440 to t3 446. That is, the CPU can save the most energy by remaining in the C1 411 power state.

As another example, during time interval 454, i.e., between t3 446 and t4 448, the overall energy cost for the CPU is lowest in the C2 421 power state, as demonstrated by the graph. Similar to the previous time interval 452, there is not enough time that would be spent in the C3 431 power state to make the energy cost of transitioning worth it. However, there is now enough time where the energy cost of entering and exiting the C2 421 state is less than the amount of energy saved by residing in that state for an amount of time, e.g., between t3 446 and t4 448. That is, the CPU can save the most energy by residing in the C2 421 power state.

As demonstrated in the graph, the overall energy cost of state C3 431 is only the lowest during time interval 456, which is any time after t4 448. That is, if the CPU has a time window that is equal to or larger than t4 448, then it is most efficient to transition the CPU from the C0 401 to C3 431 power state as the CPU finally has enough time to remain the C3 431 power state to save more energy than it exerts to enter into the power state.

The available time window for transition can be estimated by an idle governor.

The idle governor is a software component run on the CPU that is used to determine the most efficient power state for the CPU to enter into and remain during an extended time window. This can include estimating the available time window for transition for the one or more cores of the CPU. The idle governor can include programming instructions that are executed by the CPU and can perform its operations upon instruction execution.

The estimate can be based on when the next wakeup event occurs in the system. The idle governor can compare the estimated time, T, with one or more breakeven points, e.g., the respective time-points where each power state saves as much energy as it exerts or is energy neutral, to determine the power state the CPU will be in before the next task or wake up event. For example, the breakeven point for C1 401 is t0 440, e.g., any time when the CPU is not actively processing because it takes limited power to transition. As another example, the breakeven point for C2 421 power state is t3 446 and the breakeven point for the C3 431 power state is t4 488. Thus, any time spent in the power state after the breakeven point is saving the CPU power as the CPU now is saving more energy than it exerted to enter into the power state.

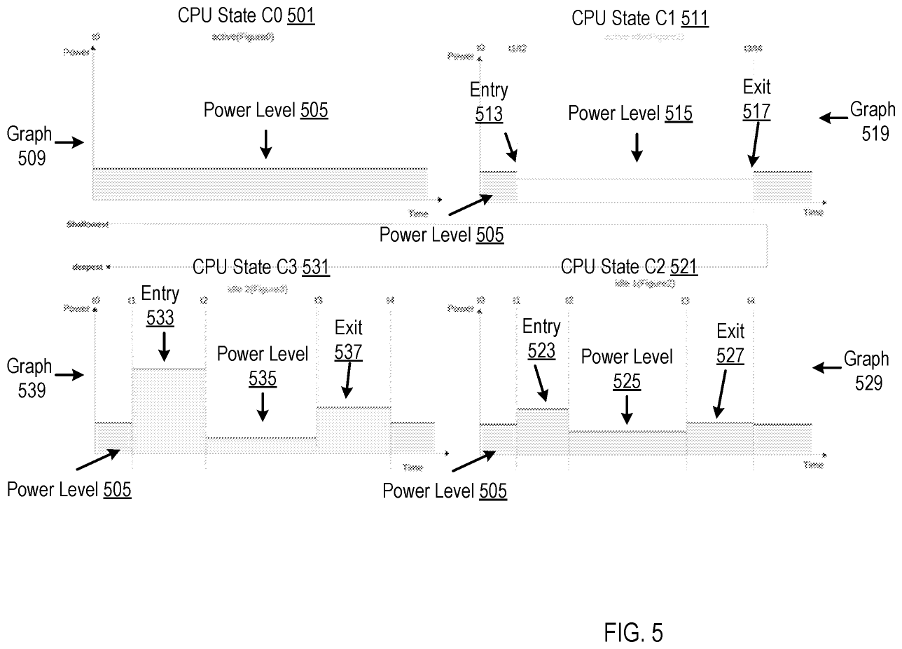

The estimation process of the idle governor is explained in further detail with reference to FIG. 5.

FIG. 5 shows multiple graphs that illustrate the power levels for the CPU power states, including entrance and exit power requirements.

As described above, in order to enter into and exit out of a particular power state of the CPU, the CPU consumes certain time and power.

The graphs of FIG. 5 illustrate the time and power necessary to enter into and exit out of each of the one or more power states as well as the baseline power level that the CPU is consuming when remaining in the power state. That is, each of the graphs illustrates the time and power level needed to enter and exit the power state as well as the amount of power consumed during the power state.

Each of the graphs denotes the entry and exit of the power level with a power level and time interval (t1-t2). While all of the time intervals are denoted as t1-t2, not all of the intervals are the same length, just as not all power levels for entrance or exit are the same height on the graph. As demonstrated in the graphs, the lower the power level, the more time and energy is required for entry and exit from that power level. For example, as seen in graph 539, the power state C3 531, e.g., the lowest power level, has the highest energy and longest entry and exit times of any of the power levels.

The graphs not only visualize the time and power differences for entering, exiting, and remaining in the one or more power states, the values can be used to solve for the breakeven points.

As described above, the breakeven points are the respective time-points where each power state saves as much energy as it exerts or is energy neutral. The breakeven points can also represent when the lower power state becomes the most efficient power state for the CPU to remain in. For example, the breakeven point t3 446 for C2 421 can also represent the overlap of energy cost of C1 411 and C2 421, as seen in FIG. 4. The breakeven point can present the starting time for the time period when C2 421 is the most efficient power state, e.g., time interval t3 446-t4 448.

To solve for breakeven points, separate test cases can be created to simulate all the low power states available in the system, e.g., the three low power states described in this specification. The CPU can then remain in the one or more low power states for an extended period of time, e.g., the time can be increased, until the two neighboring power states have the same area under the curve, e.g., have the same overall power consumption. This process can be repeated for each pair of neighboring power states until all of the breakeven points are found. These test cases can help characterize the energy cost and time latency for entering and exiting the low power states.

To calculate the overall energy consumed for a power state using an equation, all 3 sections of the above graphs, e.g., entry, baseline power level during the power state, and exit, have to be considered. The following parameters can be defined to capture the sections:
Pₑ: average power during entry
Tₑ: entry latency
Pₑₓ: average power during exit
Tₑₓ: exit latency
Pᵢ: baseline power while remaining in the state

Given this, overall energy consumed for the power state can be defined as the following, where X is the amount of time spent in the power state, e.g., the amount of time the CPU is consuming the baseline power level:

$${P}_{e 1} * {T}_{e 1} + {P}_{ex 1} * {T}_{ex 1} + {P}_{i 1} * X$$

To determine the breakeven point between two states, solve for X in the below equation to determine when the power states consume the same amount of power:

$${P}_{e 1} * {T}_{e 1} + {P}_{ex 1} * {T}_{ex 1} + {P}_{i 1} * X = {P}_{e 2} * {T}_{e 2} + {P}_{ex 2} * {T}_{ex 2} + {P}_{i 2} * X$$

$$where$$

$$X = \frac{( {P}_{e 2} * {T}_{e 2} + {P}_{ex 2} * {T}_{ex 2} - {P}_{e 1} * {T}_{e 1} + {P}_{ex 1} * {T}_{ex 1}}{( {P}_{i 1} - {P}_{i 2} )}$$

As described above, the time, or X, when two neighboring power states consume the same amount of power can also refer to the breakeven point for the lower power state.

When determining the most efficient power state to enter, or whether one can be entered at all, the idle governor can estimate the time window, or t, for the CPU based on when the next wakeup event occurs, e.g., a scheduled task or interrupt request, and compare the t with the breakeven points to determine the most efficient power state for the CPU to be in before the next wake up event. After determining the most efficient power state, the idle governor can instruct the one or more cores of the CPU to enter into the determined power state for that core. At a high level, an interrupt request can be offloaded to the embedded processor, e.g., the embedded processor 206 of FIG. 2, to enable one or more of the cores of the CPU to have an extended time window in which to enter into one of the one or more low power states. The breakeven points, as described above, can help the idle governor determine the most efficient low power state for the one or more cores of the CPU to enter, e.g., C1 411, C2 421, or C3 431 of FIG. 4.

In some implementations, the extended time window of the one or more cores of the CPU, even with offloading of the IRQ to the embedded processor, does not give the one or more cores of the CPU enough time to enter into a low power state. For example, a CPU core may have a short time window between two scheduled processing tasks.

After determining that the one or more cores of the CPU will not have enough time to enter into a low power state, the interrupt handler can determine whether the IRQ will still be routed to the embedded processor.

In some implementations, the interrupt handler can be preconfigured to send every interrupt request assigned to the embedded processor to the embedded processor, regardless of whether or not the one or more cores of the CPU will be able to enter a low power state or not.

In some implementations, the interrupt handler can dynamically determine to route the IRQ to the assigned embedded processor or the CPU based on whether one or more cores of the CPU will be able to enter a low power state or not. For example, if the idle governor determines that the one or more cores of the CPU cannot enter a low power state, the interrupt handler can override the previous determination of routing the interrupt request to the embedded processor and route the interrupt request to the one or more CPU cores for processing. Alternatively, if the idle governor determines that the one or more cores of the CPU cannot enter a low power state, the interrupt handler can nevertheless determine that the interrupt request should be routed to the embedded processor.

In some implementations, the interrupt handler can dynamically determine to route the IRQ to the assigned embedded processor of the CPU based on certain conditions. For example, the interrupt handler can dynamically determine to route specific IRQs to just CPU during low performance, e.g., if a performance monitoring system indicates low performance, the interrupt handler can determine to override the previous determining of routing the interrupt request to the embedded processor and route the interrupt request to the one or more CPU cores. In this example, the system can incur higher power for the sake of higher performance and route some or all of the interrupt requests to the CPU until performance is back to acceptable levels.

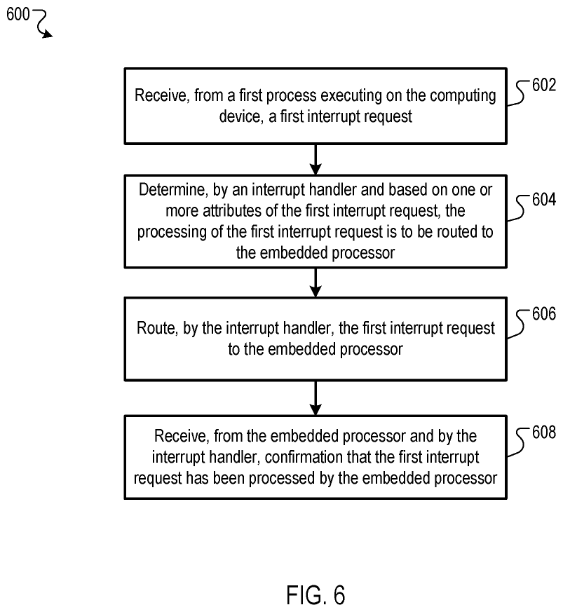

FIG. 6 shows a flow diagram of an example process of routing an interrupt request to the embedded processor. The process 600 can be executed, for example, on the interrupt handler 107 and the embedded processor 106 for illustrative purposes. One skilled in the art will appreciate that the operations of process 600 can be performed by any computing device.

The process 600 can include receiving, from a first process executing on the computing device, a first interrupt request (602).

In some implementations, the computing device is a mobile device, including a smartphone, a tablet, a laptop, and a smartwatch or wearable device, as described with reference to FIG. 1. The first process can be any process executed on a computing device, including video streaming, image enhancement processing, audio processing.

The first interrupt request can be any interrupt request, including, timer interrupts, handshaking interrupts and communication interrupts between one or more IP blocks in the SoC (as described with reference to FIG. 2). For example, the first interrupt request can be a timer interrupt that is configured to trigger after a short time interval to check for new messages or perform background updates on the mobile device.

The process 600 can further include determining, by an interrupt handler and based on one or more attributes of the first interrupt request, the processing of the first interrupt request is to be routed to the embedded processor (604).

The system can determine the routing of the first interrupt request by dynamically assigning or assigning the embedded process based on preconfiguration that identifies the first interrupt request and routes it to the embedded processor.

In some implementations of the predetermined configuration-based assignment, as described with reference to FIGS. 1 and 2, the system can identify the interrupt request (e.g., by parsing the request to access the identifier of the interrupt request) upon receipt and route it to the preconfigured processor based on a mapping (e.g., as may be stored in a table in memory) between interrupt requests and the processor to which such requests are to be routed (e.g., mapping between identifiers of interrupt requests and the respective processor to which it should be assigned).

In some implementations, for dynamic interrupt request routing, system can include one or more lookup tables (or another data structure) as part of the embedded processor that includes types of interrupts and their attributes that are to be routed to the embedded processor and types of interrupts and their attributes that are to be routed to the CPU (as described with reference to FIGS. 1 and 2). In some implementations, one lookup table can be used for types of interrupts and their associated attributes for both of the processors. In some implementations, types of interrupts and their associated attributes for the embedded processor and the CPU are stored in respective lookup tables.

The one or more attributes can be any attribute. For example, one such attribute can be whether the interrupt is host agnostic or not, e.g., whether the interrupt can be handled independently from the CPU. As a specific example, the interrupt request can be tasked to monitor a condition in the system on a periodic way to record something or notify someone and therefore, cannot be offloaded to the embedded processor.

As another example, another attribute can capture the frequency of the interrupt request.

In some implementations, the idle governor can provide an indication to the interrupt handler (either on its own or in response to a request from the interrupt handler) that the CPU can enter into a low power state if not interrupted for a given amount of time (as described with reference to FIGS. 4 and 5). In response to that indication, the interrupt handler can determine to follow the assigned routing of the interrupt request to the embedded processor.

In some implementations, the interrupt handler can receive the indication that the CPU is not able to enter into a low power state, in which case the interrupt request can still be routed to the embedded processor or could be routed to the CPU for handling instead.

In some implementations, the first interrupt request can be handled by the embedded processor in parallel to the CPU handling an additional interrupt request.

The process 600 can include routing, by the interrupt handler, the first interrupt request to the embedded processor (606). After determining the interrupt request is to be offloaded to the embedded process, the interrupt request can be routed to the embedded processor for processing (as described with reference to FIGS. 2 and 3).

The process 600 can include receiving, from the embedded processor and by the interrupt handler, confirmation that the first interrupt request has been processed by the embedded processor (608). The embedded processor can process the interrupt request and send a confirmation to the interrupt handler that the interrupt has been processed (as described with reference to FIG. 3). The interrupt handler can continue to listen for other interrupt requests and repeat the above process upon receipt of another interrupt request, while the SoC can continue to execute tasks from the first process.

As described with reference to FIG. 1, the embedded processor can be configured to have lower power consumption than the CPU, saving power in the SoC by processing the interrupt request in the embedded processor.

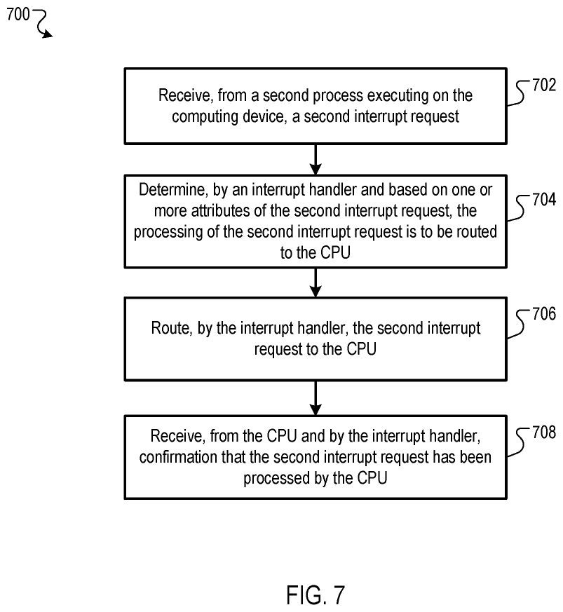

FIG. 7 shows a flow diagram of an example process 700 of routing an interrupt request to the CPU. The process 700 can be executed, for example, on the interrupt handler 107 and CPU 104 for illustrative purposes. One skilled in the art will appreciate that the operations of process 700 can be performed by any computing device.

The process 700 can include receiving, from a second process executing on the computing device, a second interrupt request (702).

In some implementations, the computing device is a mobile device, including a smartphone, a tablet, a laptop, and a smartwatch or wearable device. The first process can be any process executed on a computing device, including video streaming, image enhancement processing, audio processing.

The first interrupt request can be any appropriate interrupt request, including, timer interrupts, handshaking interrupts and communication interrupts between one or more IP blocks in the SoC (as described with reference to FIG. 2). For example, the first interrupt request can be a timer interrupt that is configured to trigger after a short time interval to check for new messages or perform background updates on the mobile device.

The process 700 can further include determining, by an interrupt handler and based on one or more attributes of the second interrupt request, the processing of the second interrupt request is to be routed to the CPU processor (704).

The system can determine the routing of the first interrupt request by dynamically assigning or assigning the embedded processor based on preconfiguration that identifies the first interrupt request and routes it to the embedded processor.

In some implementation of predetermined configuration-based assignment, as described with reference to FIGS. 1 and 2, the system can identify the interrupt request (e.g., by parsing the request to access the identifier of the interrupt request) upon receipt and route it to the preconfigured processor based on a mapping (as may be stored in a table in memory) between interrupt requests and the processor to which such requests are to be routed (e.g., mapping between identifiers of interrupt requests and the respective processor to which it should be assigned).

In some implementations, for dynamic interrupt request routing, system can include one or more lookup tables (or another data structure) as part of the embedded processor that includes types of interrupts and their attributes that are to be routed to the embedded processor and types of interrupts and their attributes that are to be routed to the CPU (as described with reference to FIGS. 1 and 2). In some implementations, one lookup table can be used for types of interrupts and their associated attributes for both of the processors. In some implementations, types of interrupts and their associated attributes for the embedded processor and the CPU are stored in respective lookup tables.

The one or more attributes can be any attribute, such as whether the interrupt is host agnostic or not, e.g., whether the interrupt can be handled independently from the CPU. As a specific example, the interrupt request can be tasked to monitor a condition in the system in a periodic way to record something or notify someone and therefore, cannot be offloaded to the embedded processor.

As another example, another attribute can capture the frequency of the interrupt request, e.g., the rate that the system receives the interrupt request.

The process 700 can include routing, by the interrupt handler, the second interrupt request to the CPU (706). After determining the interrupt request is not to be offloaded to the embedded processor, the interrupt request can be routed to the CPU for processing (as described with reference to FIGS. 2 and 3).

The process 700 can include receiving, from the CPU and by the interrupt handler, confirmation that the second interrupt request has been processed by the CPU (708). The CPU can process the interrupt request and send a confirmation to the interrupt handler that the interrupt has been processed (as described with reference to FIG. 3). The interrupt handler can continue to listen for other interrupt requests and repeat the above process upon receipt of another interrupt request, while the SoC can continue to execute tasks from the first process.

The components and processes discussed herein can be implemented on a computing system. In particular, a computing system including a computing device and/or a mobile computing device can be used to implement the techniques described herein. For example, one or more processes, electronic design tools, and data can be implemented on or stored in the computing device or the mobile computing device.

The computing device is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device includes a processor, a memory, a storage device, a high-speed interface connecting to the memory and multiple high-speed expansion ports, and a low-speed interface connecting to a low-speed expansion port and the storage device. Each of the processor, the memory, the storage device, the high-speed interface, the high-speed expansion ports, and the low-speed interface, are interconnected using various busses, and may be mounted on a common motherboard or in other manners as appropriate. The processor can process instructions for execution within the computing device, including instructions stored in the memory or on the storage device to display graphical information for a GUI on an external input/output device, such as a display coupled to the high-speed interface. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor is a single threaded processor. In some implementations, the processor is a multi-threaded processor. In some implementations, the processor is a quantum computer.

The memory stores information within the computing device. In some implementations, the memory is a volatile memory unit or units. In some implementations, the memory is a non-volatile memory unit or units. The memory may also be another form of computer-readable medium, such as a magnetic or optical disk.

The storage device is capable of providing mass storage for the computing device. In some implementations, the storage device may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor), perform one or more methods, such as those described above. The instructions can also be stored by one or more storage devices such as computer- or machine-readable mediums (for example, the memory, the storage device, or memory on the processor). The high-speed interface manages bandwidth-intensive operations for the computing device, while the low-speed interface manages lower bandwidth-intensive operations. Such allocation of functions is an example only. In some implementations, the high-speed interface is coupled to the memory, the display (e.g., through a graphics processor or accelerator), and to the high-speed expansion ports, which may accept various expansion cards (not shown). In the implementation, the low-speed interface is coupled to the storage device and the low-speed expansion port. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device may be implemented in a number of different forms, as shown in the figure. For example, it may be implemented as a standard server, or multiple times in a group of such servers. In addition, it may be implemented in a personal computer such as a laptop computer. It may also be implemented as part of a rack server system. Alternatively, components from the computing device may be combined with other components in a mobile device, such as a mobile computing device. Each of such devices may include one or more of the computing device and the mobile computing device, and an entire system may be made up of multiple computing devices communicating with each other.

The mobile computing device includes a processor, a memory, an input/output device such as a display, a communication interface, and a transceiver, among other components. The mobile computing device may also be provided with a storage device, such as a micro-drive or other device, to provide additional storage. Each of the processor, the memory, the display, the communication interface, and the transceiver, are interconnected using various buses, and several of the components may be mounted on a common motherboard or in other manners as appropriate.

The processor can execute instructions within the mobile computing device, including instructions stored in the memory. The processor may be implemented as a chipset of chips that include separate and multiple analog and digital processors. The processor may provide, for example, for coordination of the other components of the mobile computing device, such as control of user interfaces, applications run by the mobile computing device, and wireless communication by the mobile computing device.

The processor may communicate with a user through a control interface and a display interface coupled to the display. The display may be, for example, a TFT (Thin-Film-Transistor Liquid Crystal Display) display or an OLED (Organic Light Emitting Diode) display, or other appropriate display technology. The display interface may include appropriate circuitry for driving the display to present graphical and other information to a user. The control interface may receive commands from a user and convert them for submission to the processor. In addition, an external interface may provide communication with the processor, so as to enable near area communication of the mobile computing device with other devices. The external interface may provide, for example, for wired communication in some implementations, or for wireless communication in other implementations, and multiple interfaces may also be used.

The memory stores information within the mobile computing device. The memory can be implemented as one or more of a computer-readable medium or media, a volatile memory unit or units, or a non-volatile memory unit or units. An expansion memory may also be provided and connected to the mobile computing device through an expansion interface, which may include, for example, a SIMM (Single In Line Memory Module) card interface. The expansion memory may provide extra storage space for the mobile computing device, or may also store applications or other information for the mobile computing device. Specifically, the expansion memory may include instructions to carry out or supplement the processes described herein and may include secure information also. Thus, for example, the expansion memory may be provided as a security module for the mobile computing device, and may be programmed with instructions that permit secure use of the mobile computing device. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor), perform one or more methods, such as those described above. The instructions can also be stored by one or more storage devices, such as one or more computer- or machine-readable mediums (for example, the memory, the expansion memory, or memory on the processor). In some implementations, the instructions can be received in a propagated signal, for example, over the transceiver or the external interface.

The mobile computing device may communicate wirelessly through the communication interface, which may include digital signal processing circuitry in some cases. The communication interface may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 4G/5G/6G cellular, among others. Such communication may occur, for example, through the transceiver using a radio frequency. In addition, short-range communication may occur, such as using a Bluetooth, Wi-Fi, or other such transceiver (not shown). In addition, a GPS (Global Positioning System) receiver module may provide additional navigation- and location-related wireless data to the mobile computing device, which may be used as appropriate by applications running on the mobile computing device.

The mobile computing device may also communicate audibly using an audio codec, which may receive spoken information from a user and convert it to usable digital information. The audio codec may likewise generate audible sound for a user, such as through a speaker, e.g., in a handset of the mobile computing device. Such sound may include sound from voice telephone calls, may include recorded sound (e.g., voice messages, music files, among others) and may also include sound generated by applications operating on the mobile computing device.

The mobile computing device may be implemented in a number of different forms, as shown in the figure. For example, it may be implemented as a cellular telephone. It may also be implemented as part of a smart-phone, personal digital assistant, or other similar mobile device.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows can also be performed by special purpose logic circuitry, e.g., an FPGA or an ASIC, or by a combination of special purpose logic circuitry and one or more programmed computers. Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method implemented at a computing device that includes a system-on-chip comprising a central processing unit (CPU) and an embedded processor, the method comprising:
receiving, from a first process executing on the computing device, a first interrupt request;
determining, by an interrupt handler and based on one or more attributes of the first interrupt request, that processing of the first interrupt request is to be routed to the embedded processor instead of the CPU; and
routing, by the interrupt handler, the first interrupt request to the embedded processor; receiving, from the embedded processor and by the interrupt handler, confirmation that the first interrupt request has been processed by the embedded processor.

2. The method of claim 1 wherein the first interrupt request includes timer interrupts, handshaking interrupts and communication interrupts between one or more IP blocks in the system-on-chip.

3. The method of claim 1 wherein the attributes of the first interrupt request comprise whether the first interrupt request is host agnostic or not.

4. The method of claim 1 wherein the attributes of the first interrupt request comprise a frequency of the first interrupt request.

5. The method of claim 1 wherein the first interrupt request is dynamically assigned or assigned to the embedded processor based on preconfiguration that identifies the first interrupt request and routes it to the embedded processor.

6. The method of claim 5, wherein assigning based on preconfiguration further comprises, during preconfiguration:
analyzing a set of interrupt requests and for each interrupt request, determining an assigned processor; and
preconfiguring the interrupt handler to route each of the interrupt requests to the assigned processor.

7. The method of claim 5, wherein dynamically assigning the first interrupt request comprises identifying and matching one or more attributes of the first interrupt request to the embedded processor.

8. The method of claim 6 wherein dynamically assigning the first interrupt request further comprises:
comparing attributes of the first interrupt request with predetermined attributes that are aligned with processing of interrupts by the embedded processor.

9. The method of claim 1 wherein the embedded processor has lower power consumption than the CPU.

10. The method of claim 1 wherein the CPU enters into or remains in a particular low power state when the first interrupt request is routed to the embedded processor.

11. The method of claim 1 further comprising:
receiving, from a second process executing on the computing device, a second interrupt request;
determining, by the interrupt handler and based on one or more attributes of the second interrupt request, that processing of the second interrupt request is to be routed to the CPU;
routing, by the interrupt handler, the second interrupt request to the CPU; and
receiving, from the CPU and by the interrupt handler, confirmation that the second interrupt request has been processed by the CPU.

12. The method of claim 1, wherein the computing device is a mobile device and wherein the first process executed on the mobile device is a video streaming process.

13. The method of claim 12, wherein the first interrupt request is a timer interrupt that is configured to repeatedly trigger after a short time interval to check for new messages or perform background updates on the mobile device.

14. The method of claim 1 wherein the embedded processor is a synchronization and scheduling unit (SSU).
